(19) United States
(12) Patent Application Publication
(10) Pub. No.: US 2019/0373142 A1
(43) Pub. Date: Dec. 5, 2019

(54) IMAGING APPARATUS

(71) Applicant: SHARP KABUSHIKI KAISHA, Sakai City (JP)

(72) Inventors: TOMOYUKI FUJIWARA, Sakai City (JP); KENTO SORANAKA, Sakai City (JP); SAKAE SAITO, Sakai City (JP)

(21) Appl. No.: 16/422,341

(22) Filed: May 24, 2019

Related U.S. Application Data
(60) Provisional application No. 62/678,578, filed on May 31, 2018.

(51) Int. Cl. H04N 5/225; G03B 17/55

(52) U.S. Cl. CPC H04N 5/2252; G03B 17/55; H04N 5/2253; H04N 5/2254

(57) ABSTRACT

[Object] To realize an imaging apparatus that is resistant to external shock and vibrations, and quality of external appearance can be easily improved.

[Solution] An imaging apparatus (10) includes a front housing (22), a rear housing (33), and a circuit board (30) where an imaging device (31) is provided. The front housing (22) and the rear housing (33) include adhesion faces (36, 37) to be fixed by an adhesive agent (34). At least part of the adhesion faces (36, 37) has a shape where the adhesive agent (34) comes into contact with multiple faces.

### TECHNICAL FIELD

The present invention relates to an imaging apparatus suitable for onboard cameras, surveillance cameras, and medical cameras. This imaging apparatus has an imaging device such as an image sensor or the like, damage to the imaging apparatus proper and imaging functions due to shock and/or immersion in water, can be prevented, and has shock resistance and weather resistance.

### BACKGROUND ART

There are conventionally known imaging apparatuses that have a housing in which are accommodated an imaging optical system, an imaging device, and an electronic circuit portion, and a connecting cord. The imaging optical system has optical elements such as imaging lens and so forth, the imaging device is for acquiring subject images imaged by the imaging optical system, and the electronic circuit portion performs generating and so forth of image data corresponding to the subject image based on electric signals output from the imaging device. The connection cord is for transmitting the image data from the electronic circuit portion.

In particular, imaging devices used as onboard cameras or surveillance cameras are used with at least a lens exposed, and accordingly waterproofness is required. The imaging apparatus also is subjected to vibrations and shock when in use, so having weather resistance and shock resistance is required in order to prevent damage to components such as the lens or the like.

Further, reduction in size is required for onboard cameras, due to design-based requirements for automobiles. It is important for endoscopic cameras to have airtightness and resistance to chemicals, since in medical usages, inside of the human body is highly humid, and there is a possibility of being subjected to strong acid in the stomach. This is similarly true for industrial applications as well.

A technology called active alignment has been developed as a technology for adjusting focus, optical axis, and tilt, in which positional relation of the lens and image sensor is performed while imaging, and the positional relation is fixed using an adhesive agent.

PTL 1 discloses a method of applying an adhesive agent between a board and lens assembly and adjusting focus, optical axis, and tilt, and a method of applying the adhesive agent between a front housing and back housing also is disclosed. PTL 2 and PTL 3 disclose a method of applying an adhesive agent between a lens holder also serving as a front housing and a lens, and adjusting focus, optical axis, and tilt. The invention according to PTL 2 in particular restricts the adhesive agent to epoxy-amine.

### CITATION LIST

### Patent Literature

PTL 1: U.S. Pat. No. 9,277,104

PTL 2: U.S. Pat. No. 8,542,451

PTL 3: U.S. Pat. No. 9,338,334

### SUMMARY OF INVENTION

### Technical Problem

The imaging apparatuses described in PTL 1 through 3 have a waterproof structure formed by laser welding of the lens assembly and housing, but this requires resin that will transmit laser, so choices for resin are limited.

Also, in a case where the housing is metal, a method is known where a packing is interposed between housings and fixed by screws to form a waterproof structure, but this requires bosses in the housing for fastening screws, and reduction in size is not easy. A method of adhesion between housings is also disclosed for the imaging apparatuses described in PTL 1 through 3, but shock and vibrations from the outside of the camera are directly applied to the adhesive agent, so there is concern that the adjusted focus and optical axis may shift. Also, the adhesive agent extends out from the housing, which is problematic regarding the quality of the external appearance.

Thus, according to an aspect of the present invention, between housings is fixed by adhesive agent, thereby broadening the choices of resin for the housings, and bosses for fastening by screws is unnecessary even in a case of employing metal for the material of the housings, so the size of the imaging apparatus can be reduced. Also, creative design of the adhesion faces (adhesion portions) enables strength with regard to external shock and vibrations to be improved, and the quality of the external appearance can be improved since the adhesive agent does not extend out from the housing.

It is an object of the present invention to realize an imaging apparatus that is resistant to external shock and vibrations, and quality of external appearance can be easily improved.

### Solution to Problem

In order to solve the above problem, (1) an embodiment of the present invention is an imaging apparatus including a front housing, a rear housing, and a circuit board where an imaging device is provided. The front housing and the rear housing include adhesion faces to be fixed by an adhesive agent. At least part of the adhesion faces has a shape where the adhesive agent comes into contact with multiple faces.

(2) In an embodiment of the present invention, in addition to the configuration of the above (1), the adhesive agent is hardened by a heat source.

(3) In an embodiment of the present invention, in addition to the configuration of either of the above (1) and the above (2), the adhesive agent is hardened by ultraviolet rays.

(4) In an embodiment of the present invention, in addition to the configuration of any one of the above (1) through the above (3), the adhesive agent is hardened by temporary hardening for adjustment of positions of parts configuring the imaging apparatus, and complete hardening for fixing the front housing and the rear housing after the temporary hardening.

(5) In an embodiment of the present invention, in addition to the configuration of any one of the above (1) through the above (4), at least one of the front housing and the rear housing comes into contact with a ground of the circuit board via an electroconductive portion.

(6) In an embodiment of the present invention, in addition to the configuration of any one of the above (1) through the above (5), at least one of the front housing and the rear housing includes a thermal dissipation member that dissipates heat generated within the imaging apparatus.

(7) In an embodiment of the present invention, in addition to the configuration of any one of the above (1) through the above (6), at least one of the front housing and the rear housing is made of plastic.

(8) In an embodiment of the present invention, in addition to the configuration of any one of the above (1) through the above (6), at least one of the front housing and the rear housing is made of metal.

(9) In an embodiment of the present invention, in addition to the configuration of any one of the above (1) through the above (6), the front housing and the rear housing are made of metal, and the front housing and rear housing have been subjected to surface treatment to improve durability.

### Advantageous Effects of Invention

According to an aspect of the present invention, an imaging apparatus can be realized that that is resistant to external shock and vibrations, and quality of external appearance can be easily improved.

### BRIEF DESCRIPTION OF DRAWINGS

FIG. 1 is a cross-sectional view illustrating a cross-sectional configuration of an imaging apparatus according to a first embodiment of the present invention.

FIG. 2 is an external view of the imaging apparatus illustrated in FIG. 1.

FIG. 3 is a disassembled perspective view illustrating the imaging apparatus illustrated in FIG. 1 in a disassembled state.

FIG. 4 is a diagram viewing a front housing from a rear housing side.

FIG. 5 is a diagram viewing a rear housing from a front housing side.

FIG. 6 is a cross-sectional view illustrating a cross-sectional configuration of an imaging apparatus according to a second embodiment of the present invention.

FIG. 7 is a cross-sectional view illustrating a cross-sectional configuration of an imaging apparatus according to a third embodiment of the present invention.

### DESCRIPTION OF EMBODIMENTS

### First Embodiment

### (Configuration of Imaging Apparatus 10)

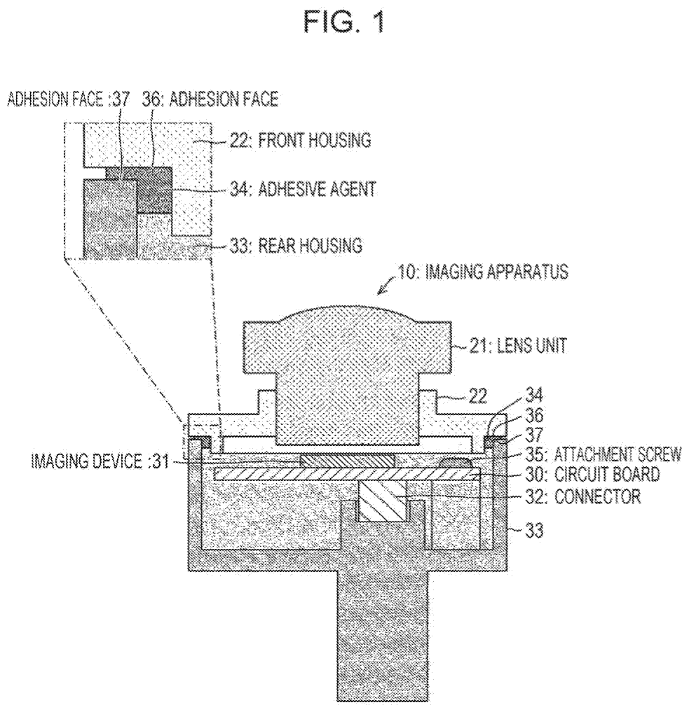

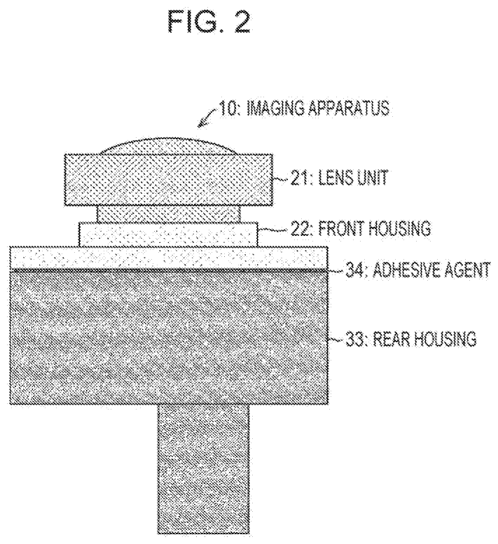

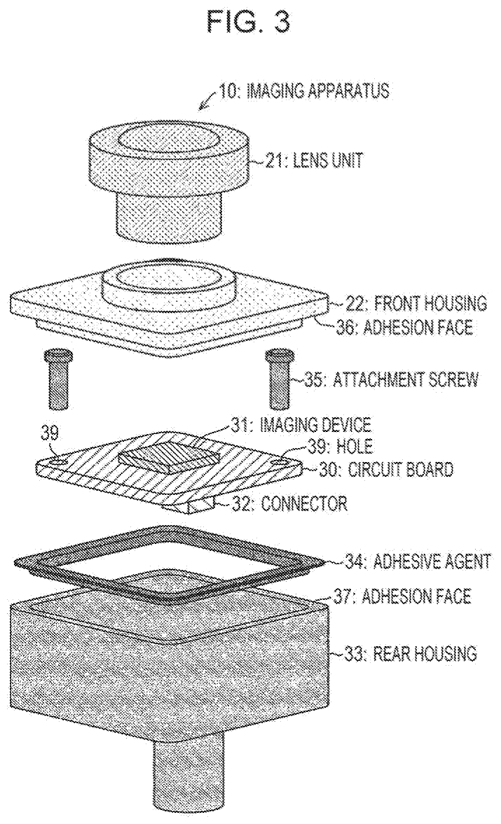

FIG. 1 is a cross-sectional view illustrating a cross sectional configuration of an imaging apparatus 10 according to a first embodiment of the present invention. FIG. 2 is an external view of the imaging apparatus 10 illustrated in FIG. 1. FIG. 3 is a disassembled perspective view illustrating the imaging apparatus 10 illustrated in FIG. 1 in a disassembled state.

As illustrated in FIG. 1 through FIG. 3, the imaging apparatus 10 includes a lens unit 21, a front housing 22, a circuit board 30 (mounted board), an imaging device 31, a connector 32, a rear housing 33, and attachment screws 35. The lens unit 21 has at least one lens, and a lens barrel bearing the lens. The lens unit 21 is also fixed to the front housing 22 by screws (omitted from illustration) and/or adhesive agent (omitted from illustration).

The front housing 22 and rear housing 33 are a shell-structure case (container) that accommodates the various parts making up the imaging apparatus 10 therein, and protect these various parts. Specifically, the front housing 22 and rear housing 33 accommodate the circuit board 30, imaging device 31, connector 32, and attachment screw 35 therein.

The front housing 22 is fixed to the rear housing 33 by adhesive agent 34. Due to the front housing 22 and the rear housing 33 having been fixed, the circuit board 30, imaging device 31, connector 32, and attachment screw 35 are accommodated within the front housing 22 and rear housing 33.

The front housing 22 has an adhesion face 36 (Adhesion portion) that is fixed by the adhesive agent 34, and the rear housing 33 has an adhesion face 37 (adhesion portion) that is fixed by the adhesive agent 34. At least part of the adhesion face 36 and adhesion face 37 have forms where the adhesive agent 34 comes into contact with multiple faces.

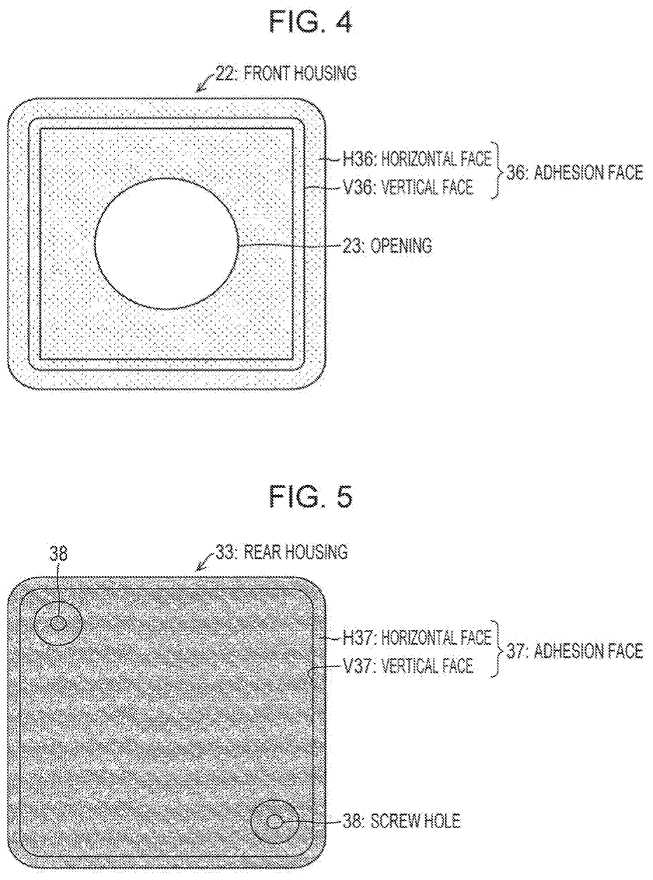

Specifically, the adhesion face 36 may have a horizontal face H36 and a vertical face V36, and the adhesion face 37 may have a horizontal face H37 and a vertical face V37, as illustrated in FIG. 4 and FIG. 5, for example. FIG. 4 is a diagram viewing the front housing 22 from the rear housing 33 side. FIG. 5 is a diagram viewing the rear housing 33 from the front housing 22 side. The adhesive agent 34 is in contact with the horizontal faces H36 and H37, and the vertical faces V36 and V37.

The horizontal faces H36 and H37 are faces parallel to the direction in which the circuit board 30 extends, and the vertical faces V36 and V37 are faces perpendicular to the direction in which the circuit board 30 extends. The horizontal face H36 and vertical face V36 are mutually orthogonal, and the horizontal face H37 and vertical face V37 are mutually orthogonal. The horizontal face H36 and horizontal face H37 are parallel to each other, and the vertical face V36 and vertical face V37 are parallel to each other.

Accordingly, the front housing 22 and rear housing 33 can be powerfully adhered to each other. Also, an imaging apparatus 10 that is resistant to shock and vibrations from outside of the imaging apparatus 10 can be realized, regardless of the material of the front housing 22 and rear housing 33. Accordingly shift occurring in the adjusted focus and optical axis can be reduced. Also, processing for reducing the roughness of the surface of the front housing 22 and rear housing 33 is unnecessary, as compared to a case of interposing a packing between the front housing 22 and rear housing 33 to secure waterproofness. Accordingly, processing of the front housing 22 and rear housing 33 is easier, and reduction in manufacturing costs of the imaging apparatus 10 can be realized.

Further, bosses for fastening by screws to be fixed to each other are unnecessary for the front housing 22 and rear housing 33, thereby enabling reduction in size and reduction of manufacturing costs of the imaging apparatus 10, so a larger circuit board 30 can be installed. Also, at least part of the adhesion face 36 and adhesion face 37 are shaped so that the adhesive agent 34 comes into contact with multiple faces, so a configuration where the adhesive agent 34 does not extend to the outer side from the front housing 22 and rear housing 33 can easily be realized, as illustrated in FIG. 2. Accordingly, the quality of external appearance of the imaging apparatus 10 can be easily improved.

An opening 23 may be formed in the front housing 22, for the lens unit 21 to fit into the front housing 22, as illustrated in FIG. 4. Screw holes 38 may also be formed in the rear housing 33 into which the attachment screws 35 are inserted as illustrated in FIG. 5, and holes 39 may be formed on the circuit board 30 for the attachment screws 35 to pass through, as illustrated in FIG. 3. The attachment screws 35 pass through the holes 39 and enter the screw holes 38.

The attachment screws 35 are for fixing the circuit board 30 to the rear housing 33. Although the circuit board 30 is fixed to the rear housing 33 in the present embodiment, the circuit board 30 may be fixed to the front housing 22.

At least one of the front housing 22 and rear housing 33 is made of plastic or metal. The term “made of” plastic or metal does not necessarily indicate being made of only plastic or metal, and indicates that at least one of the front housing 22 and rear housing 33 may be made of made of an arrangement including a component additionally provided to plastic or metal, in addition to plastic or metal.

A component additionally provided to plastic or metal is a material or the like used when shaping at least one of the front housing 22 and rear housing 33, for example. That is to say, the term “made of” plastic or metal indicates that the primary material configuring at least one of the front housing 22 and rear housing 33 is plastic or metal.

Specifically, examples of material shaping at least one of the front housing 22 and rear housing 33 include, as thermoplastic resin, polyvinyl chloride (PVC), polyvinylidene chloride (PVDC), polyethylene (PE), polybutylene terephthalate (PBT), polypropylene (PP), polystyrene (PS), ABS resin, methacrylic resin (PMMA), nylon 66, polyacetal (POM), polycarbonate (PC), and polyvinylidene fluoride (PVDF) and so forth.

Also, examples of material shaping at least one of the front housing 22 and rear housing 33 include, as thermosetting resin, phenyl resin, urea resin, melamine resin, unsaturated polyester, epoxy resin, silicone resin, and polyurethane reason and so forth.

Also, examples of material shaping at least one of the front housing 22 and rear housing 33 include, as high heat-resistance resin or durable resin, polysulfone (PSU), polyether sulfone (PES), polyphenylene sulfide (PPS), polyacrylate (PAR), polyamide imide (PAI), polyether imide (PEI), polyether ether ketone (PEEK), polyimide (PI), liquid crystal polymer (LC), and polytetrafluoroethylene (PTEF) and so forth.

Also, examples of material shaping at least one of the front housing 22 and rear housing 33, metal such as aluminum alloy, magnesium alloy, steel, nickel, nickel-iron alloy, stainless steel (SUS), or the like, may be used.

For example, a case will be considered where the front housing 22 and rear housing 33 are made of metal. In this case, the effects of external radiating noise, and unnecessary radiating noise to the outside, can be reduced, by the gap between the front housing 22 and the rear housing 33 being closed off by the adhesive agent 34. Also, in a case where at least one of the front housing 22 and rear housing 33 is made of plastic, the weight of the imaging apparatus 10 can be reduced.

Materials for the front housing 22 and rear housing 33 are not restricted to the materials exemplified above, as long as the front housing 22 and rear housing 33 can be formed.

Note that in a case where the front housing 22 and rear housing 33 are made of metal, surface treatment processing for improving durability may be performed on the front housing 22 and rear housing 33. Specifically, surface treatment processing such as alumite or electro-deposition coating may be performed on the front housing 22 and rear housing 33. Accordingly, the durability of the front housing 22 and rear housing 33 can be improved, and the strength of the imaging apparatus 10 can be improved.

The circuit board 30 is fixed to the rear housing 33 by at least one attachment screw 35. The imaging device 31 is attached to the face of the circuit board 30 that is toward the lens unit 21 side. The imaging device 31 is an electronic part that converts incident light to a lens that the lens unit 21 has into electrical signals. The connector 32 is provided to the face of the circuit board 30 that is toward the rear housing 33 side. The connector 32 is for transmitting imaged images imaged by the imaging device 31 outside of the imaging apparatus 10, and for supplying electric power to electronic parts (omitted from illustration) provided inside the imaging apparatus 10.

An IC (Integrated Circuit) for image processing, an IC for communication, an IC for power source, other ICs, capacitors, and resistors and so forth may be mounted on the circuit board 30. A sensor mounted on the circuit board 30 may be a CMOS (Complementary Metal-Oxide Semiconductor), CCD (Charge-Coupled Device), and arrangements that receive infrared rays, ultraviolet trays, and X-rays, other than visible light. Also, the circuit board 30 may be multiple boards connected by the connector 32 or a flexible printed board (omitted from illustration).

### (Method of Fixing Adhesive Agent 34)

The adhesive agent 34 hardness by temporary hardening for adjusting the position of parts making up the imaging apparatus 10, and complete hardening for fixing the front housing 22 and rear housing 33 after the temporary hardening. This will be described below in detail.

Temporary hardening by the adhesive agent 34 is performed on the front housing 22 to which the lens unit 21 has been fixed, and the rear housing 33 to which the circuit board 30 provided with the imaging device 31 has been fixed, while adjusting the positions of the parts making up the imaging apparatus 10. Accordingly, the relatively position of the lens unit 21 and the imaging device 31 can be tentatively fixed.

Positioning of the front housing 22 and rear housing 33 is performed by moving the imaging device 31 along an X axis, Y axis, and Z axis, with respect to the lens unit 21, and rotationally moving with the X axis, Y axis, and Z axis ax rotational axes. The X axis, Y axis, and Z axis are axes that are orthogonal to each other.

After the temporary hardening, complete hardening is performed at the adhesive agent 34, whereby the front housing 22 and rear housing 33 are completely fixed by the adhesive agent 34. Thus, the adhesive agent 34 is hardened by temporary hardening and complete hardening, so positioning of the front housing 22 and rear housing 33 can be performed accurately and easily. Thus, high-precision images can be obtained by the imaging apparatus 10, due to the positioning having been accurately performed.

The method of temporary hardening and complete hardening of the adhesive agent 34 may be a hardening method by a heat source, a hardening method by ultraviolet rays (UV), or another hardening method by which the adhesive agent 34 can be hardened.

Note that a case in which the adhesive agent 34 is hardened by two-stage hardening of temporary hardening and complete hardening is described in the present embodiment, but this is not restrictive. For example, the adhesive agent 34 may be hardened by one-stage hardening. Also, the adhesive agent 34 may be hardened by an appropriate combination of a hardening method by a heat source, a hardening method by ultraviolet rays, or another hardening method.

### Second Embodiment

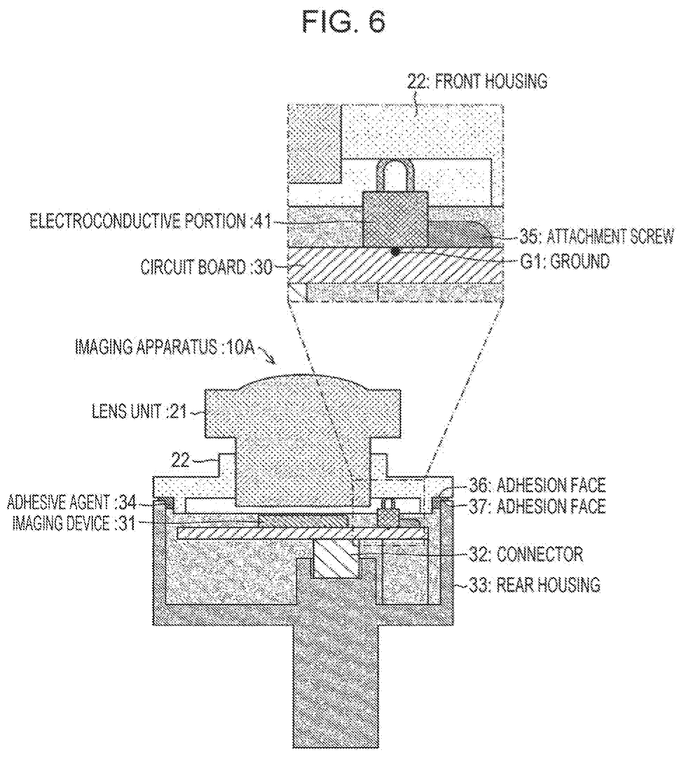

FIG. 6 is a cross-sectional view illustrating a cross-sectional configuration of an imaging apparatus 10A according to a second embodiment of the present invention. Note that members having the same functions as the members described in the above embodiment will be denoted by the same symbols, and description thereof will not be repeated, in order to facilitate description.

The imaging apparatus 10A differs from the imaging apparatus 10 with regard to the point of having an electroconductive portion 41 (contact pin), as illustrated in FIG. 6. The electroconductive portion 41 is in contact with a ground G1 of the front housing 22 and circuit board 30. The electroconductive portion 41 may be a spring of a thin plate of metal, electroconductive rubber, or another member that has electroconductivity.

Note that the electroconductive portion 41 may be in contact with the rear housing 33 instead of the front housing 22, or may be in contact with both the front housing 22 and the rear housing 33.

Accordingly, at least one of the front housing 22 and rear housing 33 is in contact with the ground G1 of the circuit board 30 via the electroconductive portion 41. Thus, covering the circuit board 30, imaging device 31, and connector 32 by the front housing 22 and rear housing 33 enables the effects of external radiating noise, and unnecessary radiating noise to the outside, to be reduced, for example. Malfunctioning of the imaging apparatus 10A due to external radiating noise can also be prevented. Note that the electroconductive portion 41 may be mounted on the circuit board 30, or may be mounted to the rear housing 33 by the attachment screws 35 along with the circuit board 30.

### Third Embodiment

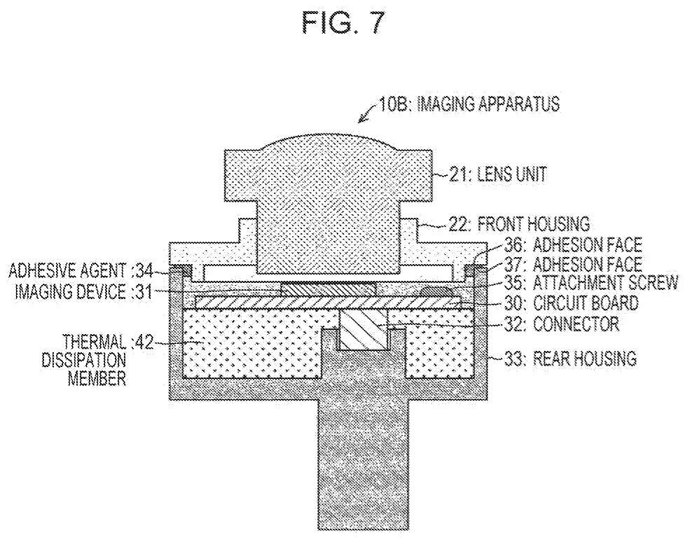

FIG. 7 is a cross-sectional view illustrating a cross-sectional configuration of an imaging apparatus 10B according to a third embodiment of the present invention. Note that members having the same functions as the members described in the above embodiment will be denoted by the same symbols, and description thereof will not be repeated, in order to facilitate description.

The imaging apparatus 10B differs from the imaging apparatus 10 with regard to the point of having a thermal dissipation member 42, as illustrated in FIG. 7. The thermal dissipation member 42 is a member for dissipating heat generated within the imaging apparatus 10B. Specifically, the thermal dissipation member 42 may be a filler, graphite sheet, or some other thermal dissipation member. The thermal dissipation member 42 dissapates heat from parts that generate a great deal of heat, such as the imaging device 31, circuit board 30, and so forth, to the outside of the imaging apparatus 10B.

The thermal dissipation member 42 is in contact with the face of the circuit board 30 that is toward the rear housing 33 side, the connector 32, and the rear housing 33. Heat generated within the imaging apparatus 10B is dissipated to the outside of the imaging apparatus 10B via the thermal dissipation member 42 and rear housing 33. Note that the thermal dissipation member 42 may be in contact with the front housing 22 and the face of the circuit board 30 toward the front housing 22 side. In a case where multiple circuit boards 30 are layered, the thermal dissipation member 42 may be disposed between the circuit boards 30.

Accordingly, at least one of the front housing 22 and rear housing 33 includes the thermal dissipation member 42. Accordingly, heat generated within the imaging apparatus 10B can be dissipated to the outside of the imaging apparatus 10B. Thus, trouble due to high temperatures within the imaging apparatus 10B can be prevented. Also, heat can be efficiently dissipated by bringing the thermal dissipation member 42 into contact with at least one of the front housing 22 and rear housing 33.

### Summarization

An imaging apparatus according to a first form of the present invention includes a front housing, a rear housing, and a circuit board where an imaging device is provided. The front housing and the rear housing include adhesion faces to be fixed by an adhesive agent. At least part of the adhesion faces has a shape where the adhesive agent comes into contact with multiple faces.

In a second form of the present invention, a configuration may be made in the above first form where the adhesive agent is hardened by a heat source.

In a third form of the present invention, a configuration may be made in the above first form where the adhesive agent is hardened by ultraviolet rays.

In a fourth form of the present invention, a configuration may be made in the above first form where the adhesive agent is hardened by temporary hardening for adjustment of positions of parts configuring the imaging apparatus, and complete hardening for fixing the front housing and the rear housing after the temporary hardening.

In a fifth form of the present invention, a configuration may be made in the above first form where at least one of the front housing and the rear housing comes into contact with a ground of the circuit board via an electroconductive portion.

In a sixth form of the present invention, a configuration may be made in the above first form where at least one of the front housing and the rear housing includes a thermal dissipation member that dissipates heat generated within the imaging apparatus.

In a seventh form of the present invention, a configuration may be made in the above first form where at least one of the front housing and the rear housing is made of plastic.

In an eighth form of the present invention, a configuration may be made in the above first form where at least one of the front housing and the rear housing is made of metal.

In a ninth form of the present invention, a configuration may be made in the above first form where the front housing and the rear housing are made of metal, and the front housing and rear housing have been subjected to surface treatment to improve durability.

The present invention is not restricted to the above-described embodiments, rather, various modifications may be made within the scope set forth in the Claims, and embodiments obtained by appropriately combining technical means disclosed in different embodiments are also encompassed by the technical scope of the present invention. Further, new technical features can be formed by combining technical means disclosed in the embodiments.

### REFERENCE SIGNS LIST

10, 10A, 10B imaging apparatus
21 lens unit
22 front housing
23 opening
30 circuit board
31 imaging device
32 connector
33 rear housing
34 adhesive agent
35 attachment screw
36, 37 adhesion faces
38 screw hole
41 electroconductive portion
42 thermal dissipation member
G1 ground
H36, H37 horizontal faces
V36, V37 vertical faces

1. An imaging apparatus comprising:
a front housing; a rear housing; and a circuit board where an imaging device is provided,
wherein the front housing and the rear housing include adhesion faces to be fixed by an adhesive agent,
and wherein at least part of the adhesion faces has a shape where the adhesive agent comes into contact with multiple faces.

2. The imaging apparatus according to claim 1, wherein the adhesive agent is hardened by a heat source.

3. The imaging apparatus according to claim 1, wherein the adhesive agent is hardened by ultraviolet rays.

4. The imaging apparatus according to claim 1, wherein the adhesive agent is hardened by temporary hardening for adjustment of positions of parts configuring the imaging apparatus, and complete hardening for fixing the front housing and the rear housing after the temporary hardening.

5. The imaging apparatus according to claim 1, wherein at least one of the front housing and the rear housing comes into contact with a ground of the circuit board via an electroconductive portion.

6. The imaging apparatus according to claim 1, wherein at least one of the front housing and the rear housing includes a thermal dissipation member that dissipates heat generated within the imaging apparatus.

7. The imaging apparatus according to claim 1, wherein at least one of the front housing and the rear housing is made of plastic.

8. The imaging apparatus according to claim 1, wherein at least one of the front housing and the rear housing is made of metal.

9. The imaging apparatus according to claim 1, wherein the front housing and the rear housing are made of metal,
and wherein the front housing and rear housing have been subjected to surface treatment to improve durability.
